(19) United States
(12) Patent Application Publication
(10) Pub. No.: US 2005/0280511 A1
(43) Pub. Date: Dec. 22, 2005

(54) IC tag module, electronic device, information communication system, and communication control method for an IC tag module

(76) Inventors: Kazuyuki Yokoyama, Suwa-shi (JP); Akihiro Goto, Suwa-shi (JP)

Correspondence Address: EPSON RESEARCH AND DEVELOPMENT INC;INTELLECTUAL PROPERTY DEPT, 150 RIVER OAKS PARKWAY, SUITE 225, SAN JOSE, CA, 95134, US

(21) Appl. No.: 11/154,003

(22) Filed: Jun. 16, 2005

(30) Foreign Application Priority Data
Jun. 17, 2004 (JP) 2004-179591

(51) Int. Cl. H04Q 5/22

(52) U.S. Cl. 340/10.5; 340/10.34; 340/572.1

(57) ABSTRACT

An IC tag module enables data communication with, and receipt of power from, an external unit through a wireless port and enables the same with an electronic device in which the IC tag module is incorporated through a wired port, which includes a wired communication port and a wired power supply port. The IC tag module further includes a power supply circuit unit for combining power supplied from both the wireless port and the wired power supply port and for supplying the combined power supply to the IC tag module. A data storage circuit unit of the IC tag module stores data received through the communication ports, and a control circuit controls the operation of the module. The power supply circuit detects whether power is supplied first through the wireless port or the wired power supply port. If power is supplied from both ports, the control circuit enables communication with the data storage circuit unit through the port from which power was supplied first, and disables communication through the other port.

### BACKGROUND OF THE INVENTION

1. Field of the Invention

The present invention relates to an IC tag module, an electronic device, an information communication system, and a communication control method for an IC tag module capable of data communication through a wireless port and a wired port.

2. Description of the Related Art

IC tag modules, such as radio frequency identification (RFID) tag modules, enabling the wireless reading and writing of information, are widely used today. See, for example, Japanese Unexamined Patent Appl. Pub. 2003-224677.

Such IC tag modules generally send and receive data and obtain power only through a wireless port. Using a wireless port for data communication and for the power supply works sufficiently when the IC tag module is used independently. When the IC tag module is incorporated in an electronic device such as an information device or home appliance, however, the IC tag module cannot interact with the control circuit of the electronic device.

### SUMMARY OF THE INVENTION

The present invention is directed to solving the foregoing problem by providing an IC tag module capable of data communication with an electronic device in which the IC tag module is incorporated through a wired port and data communication with an external device through a wireless port. In other aspects, the invention provides an electronic device incorporating the module, an information communication system incorporating the device and module, and a communication control method for such an IC tag module.

To achieve the foregoing object, an IC tag module according to one aspect of the present invention comprises a wireless port through which the IC tag module is adapted to send and receive data and to receive power wirelessly; a wired port including a wired communication port through which the IC tag module is adapted to send and receive data and a wired power supply port through which the IC tag module is adapted to receive power; a power supply circuit configured to combine power received through the wireless port and the wired power supply port and to supply power to the IC tag module; a data storage medium configured to store data received through the wireless port and wired communication port; and a control circuit configured to control the IC tag module.

The power supply circuit detects whether power is first supplied through the wireless port or the wired port, and if power is being supplied through both ports, the control circuit enables communication between the data storage medium and the port through which power was supplied first and disables communication through the other port.

By thus having a wired port in addition to a wireless port, the wired port can be used for data communication with an electronic device. Furthermore, by connecting the wired port to the control circuit and power supply circuit of the electronic device, the IC tag module can be used installed inside the electronic device. Yet further, by enabling and disabling communication with the data storage medium based on when power supply starts and through which port, data can be transmitted through both ports to and the same data storage medium.

Communication is preferably enabled through the port (wireless or wired) through which the power is supplied. More specifically, if power is supplied from the other port when the power supply from the port from which power was supplied first is interrupted, communication is preferably immediately enabled through the other port. Furthermore, instead of incorporating and using the IC tag module inside the electronic device, the IC tag module can be connected through its wired port to an external data communication port disposed to the electronic device to enable data communication with the electronic device.

In this situation the control circuit preferably returns a communication disabled status message to a device that asserted a communication request when such a communication request is asserted through whichever port is disabled.

When a communication request is asserted, this arrangement enables the control circuit to inform the device (any terminal capable of communicating data through the wireless port or the wired port) for which communication is disabled that communication is currently not possible.

Further preferably, when a communication request is received through the disabled communication port (either the wired port or the wireless port), the control circuit detects if the communication-enabled port is currently being used for data communication, and returns a communication disabled status message if the enabled port is in use or switches the enabled/disabled status of both ports if the enabled port is not in use.

Instead of simply reporting that communication is disabled when a communication request is received from a device for which communication is disabled, this arrangement switches the enabled/disabled status of both ports based on whether the communication-enabled port is currently busy, and can thus enable communication with a communication device for which communication is currently turned off. The enabled/disabled status of both ports can thus be switched without needing to first interrupt the power supply from the communication-enabled port.

Yet further preferably, the control circuit switches the enabled/disabled status of both ports when a command for switching communication to the other port is received from whichever port is enabled.

This arrangement enables easily switching the enabled/disabled status of both ports when a command for switching communication to the other port is received from the enabled communication port, without needing to first interrupt the power supply from the communication-enabled port.

Yet further preferably, the power supply circuit regularly detects from which port (wireless or wired) power is being supplied; and when a command for switching communication to the other port is received from the enabled port, the control circuit first confirms that power is being supplied from the other port before switching the enabled/disabled status of both ports.

Data communication control can thus be reliably passed to the other communication port when a command for switching communication to the other port is received from a communication-enabled device, after first confirming that power is being supplied from the other port before switching communication control.

According to another aspect the invention involves an electronic device that includes an IC tag module as described above. The electronic device further comprises a device control circuit for sending data to and receiving data from the IC tag module through the wired communication port, and a device power supply circuit for supplying power to the IC tag module through the wired power supply port.

By having an internal IC tag module, the electronic device can exchange data with the data storage medium of the IC tag module, and can operate in conjunction with an external device in communication with the module through its wireless port.

In another aspect, the invention involves an information communication system that includes an IC tag module as described above; an electronic device for sending data to and receiving data from the IC tag module, and for supplying power to the module through its wired port; and a wireless communication terminal for sending data to and receiving data from the IC tag module, and for supplying power to the module through its wireless port. The IC tag module stores parameter settings of the electronic device in the data storage medium, the wireless communication terminal reads and writes the parameter settings in the data storage medium through the wireless port, and the electronic device reads the parameter settings written in the data storage medium through the wired port, and customizes the electronic device based on the parameter settings or changes the parameter settings.

By storing parameter settings of the electronic device in the data storage medium of the IC tag module, the electronic device can be customized as desired by the customer prior to shipping, without opening the product packaging or connecting a power supply. The parameter settings of the electronic device can also be changed while the electronic device is operating, without changing the interface connection.

The electronic device preferably writes one or more of the following in the data storage medium through the wired port: electronic device maintenance information and/or error log information; and the wireless communication terminal reads and writes at least one of these in the data storage medium through the wireless port.

By storing maintenance information and/or an error log for the electronic device in the data storage medium of the IC tag module, data can be easily read from the wireless communication terminal even when the electronic device is a stand-alone device (such as a device without an external communication port and unable to receive data from a higher level host terminal, or a device without a human interface for reading and writing internal data), and this information can thus be used effectively, for example, when a malfunction occurs. Because the maintenance information can also be read from the wireless communication terminal when the electronic device is installed (regardless of whether the electronic device is operating or not and regardless of the on/off status of the power supply), the maintenance information can also be used for preventive maintenance. When parts are replaced in the electronic device, the wireless communication terminal can also write repair data into the data storage medium and this repair data can then be read and used for subsequent repair and maintenance.

This maintenance information includes, for example, information about how many times parts with a certain life cycle have been used, the consumption or remaining amount of consumable goods, the operating time of the device, and a parts replacement history.

The error log stores information about errors that occurred in the electronic device with which the IC tag module is used. The error log also contains error data such as information that is recorded when the electronic device is used improperly or illegally, and errors that occur when the program does not run normally.

The data storage medium preferably stores ID information identifying the electronic device.

The type of data read from the electronic device by the wireless communication terminal is not necessarily known to the wireless communication terminal and therefore cannot be interpreted without acquiring data format information. By storing ID information identifying the electronic device in the data storage medium, the required formatting information can be acquired from a website maintained by the device manufacturer, for example, based on this ID information.

In accordance with a further aspect of the invention, a communication control method for an IC tag module that is capable of data communication through a wireless port and a wired port is provided. The communication control method includes switching the enabled/disabled status of each port according to a communication request asserted through the wireless port or wired port, whichever is currently enabled.

This arrangement enables data communication with the electronic device through the wired port, and enables using the IC tag module assembled inside the electronic device by connecting the wired port to the control circuit and power supply circuit in the electronic device.

Furthermore, because communication is enabled and disabled according to the presence of communication requests from the currently enabled port, data can be smoothly communicated with a device connected though both ports. If a communication request is received through both the wireless port and the wired port, communication is preferably enabled for the port through which the first communication request is received.

Power is preferably supplied to the IC tag module through the wireless port and wired port, and the enabled/disabled status of each port is preferably switched according to presence or absence of a communication request and presence or absence of supply power.

Communication can thus be reliably switched between the communication ports because communication is enabled or disabled based on whether a communication request is received and on what port and whether supply power is received and on what port.

Note that switching the enabled/disabled status of each port according to the presence of supply power means that communication is enabled only through the port through which power is supplied. Therefore, if a communication request is received from a port but power is not also supplied from that port, communication is not enabled through that port. In addition, if the power supply from the port through which the communication request was received is interrupted after the communication request is received, communication is switched to the other port.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is a block diagram of an information communication system according to embodiments of the present invention;

FIGS. 2A, 2B, 2C and 2D show various module arrangements and methods of mounting an RFID tag module according to embodiments of the present invention;

FIG. 3 is a functional block diagram of an RFID tag module according to embodiments of the present invention;

FIG. 4 shows an exemplary memory map for use with an RFID tag module according to an embodiment of the present invention;

FIG. 5 shows an example of the status area portion of the memory map; and

FIGS. 6A and 6B show some methods of incorporating an RFID tag module into an electronic device.

### DESCRIPTION OF THE PREFERRED EMBODIMENTS

Preferred embodiments of an IC tag module, an electronic device, an information communication system, and a communication control method for an IC tag module according to various aspects of the present invention are described below with reference to the accompanying figures.

The IC tag module of the present invention has, in addition to a wireless port for communicating with an external device, a wired port for data communication with an electronic device and for receiving operating power supplied from the electronic device. More particularly, the IC tag module enables communication with an internal data storage circuit unit through the same port through which operating power is being supplied and disables communication through the other port. Priority is decided, for example, based on the time at which power starts being supplied through one or both of the ports. With this arrangement, the IC tag module allows data to be transmitted through both ports to and from the same data storage circuit unit.

An IC tag module and an electronic device incorporating such a module according to the present invention are described below using, by way of example, an RFID tag module that enables wireless communication by means of radio frequency identification. An information communication system and a communication control method in which parameter settings, maintenance information and an error log for the electronic device are written into and read from the data storage circuit unit of the RFID tag module are also described below.

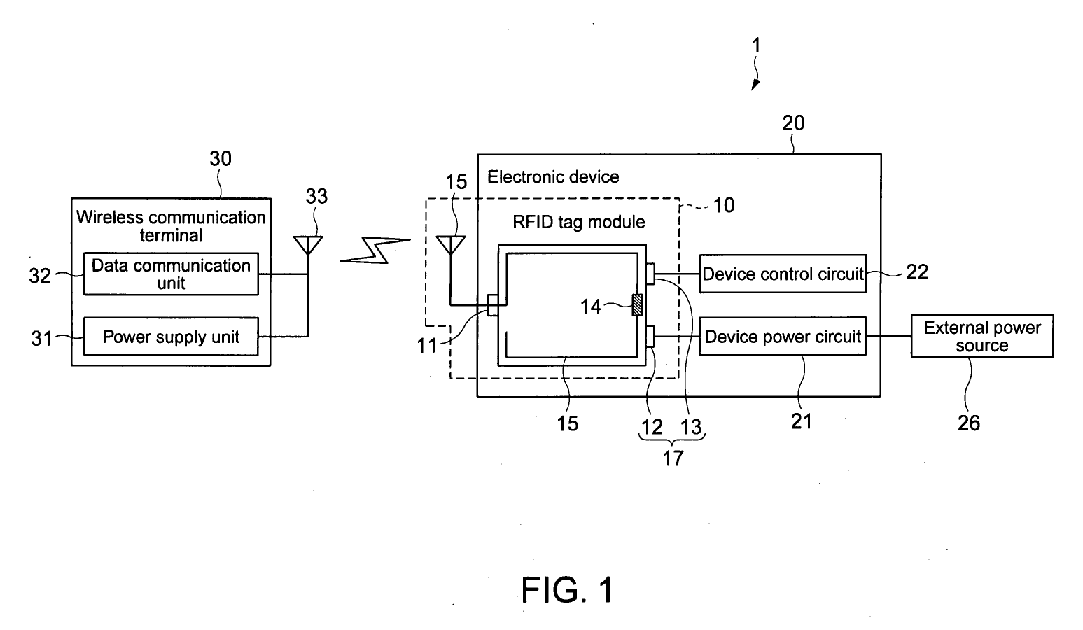

An information communication system 1 according to the present invention is described first with reference to FIG. 1. As shown in the figure this information communication system 1 includes an RFID tag module 10, an electronic device 20 incorporating the module 10, and a wireless communication terminal 30 that includes an RFID reader/writer function for wirelessly reading and writing information and that also includes the ability to supply power to RFID tag module 10.

RFID tag module 10 is a passive tag without a battery. Module 10 has a wireless port 11 for sending data to, and receiving data and power from, the wireless communication terminal 30 over a wireless connection, a wired power supply port 12 for receiving power over a wired circuit from electronic device 20, and a wired communication port 13 for sending data to, and receiving data from, electronic device 20 over a wired connection. RFID tag module 10 further includes a semiconductor chip 14 composed of memory circuits and control circuits, and a module antenna 15 in communication with wireless port 11 enabling wireless communication with wireless communication terminal 30. Wired power supply port 12 and wired communication port 13 are sometimes collectively referred to as wired port 17.

Electronic device 20, in which RFID tag module 10 is contained, includes a device power supply circuit 21, which is connected to an external power source 26 and which supplies power received from external power source 26 to the RFID tag module 10. Electronic device 20 also includes a device control circuit 22 that is connected to wired communication port 13 and that controls the internal operation of the electronic device.

Wireless communication terminal 30 includes a power supply unit 31 for supplying power to RFID tag module 10 through wireless port 11, a data communication unit 32 for sending data to and receiving data from RFID tag module 10 also through wireless port 11, and a terminal antenna 33 for sending radio waves (RF energy) to module antenna 15 of RFID tag module 10 to enable wireless communication between terminal 30 and module 10.

The information communication system 1 thus comprised exchanges data with device control circuit 22 of electronic device 20 using wired communication port 13 and receives power supplied from device power circuit 21 of the electronic device 20 using wired power supply port 12. This information communication system 1 can also switch between wireless communication port 11 and wired communication port 13 based on which port the power supply is provided and when, communication requests, and/or communication switching commands from these ports 11, 12, 13. Switching the communication state is further described below.

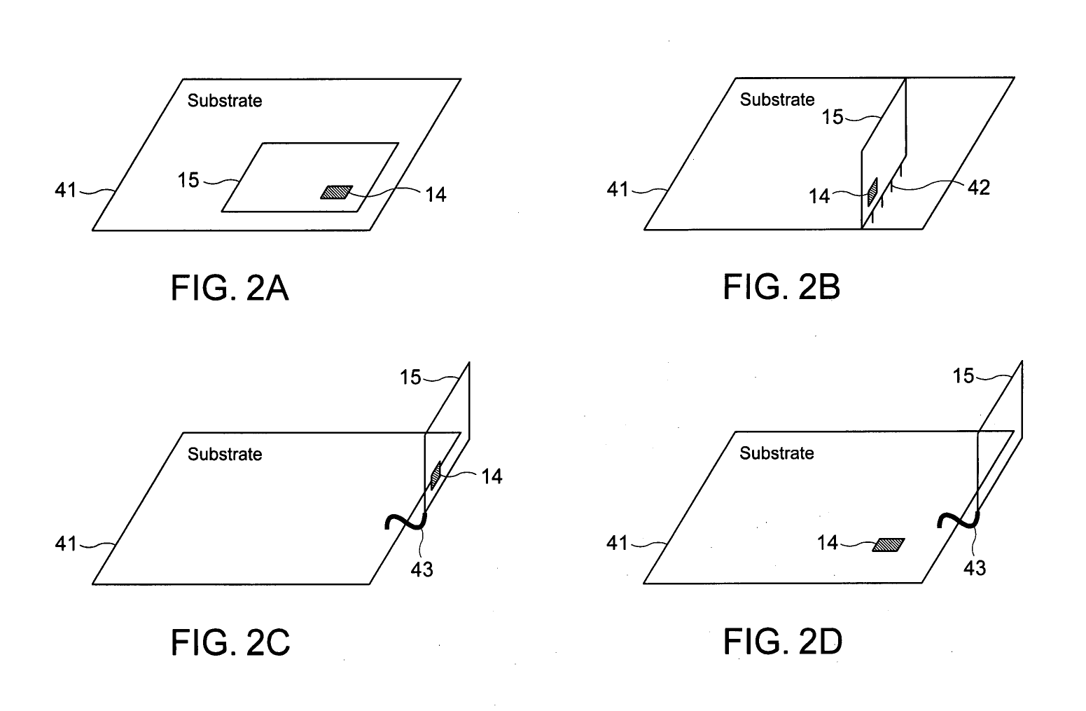

The form of RFID tag module 10 and how it can be disposed for use with electronic device 20 is described next with reference to FIG. 2. FIG. 2A shows an arrangement in which module antenna 15 is patterned on a substrate 41, and a single semiconductor chip 14 is mounted (supplied) on substrate 41 as module 10. This arrangement assumes that sufficient space is available on substrate 41 and that the positioning and arrangement of electronic device 20 are not affected by RF interference. The arrangement provides the advantage of enabling incorporating (installing) RFID tag module 10 into electronic device 20 very inexpensively.

FIG. 2B shows an arrangement in which semiconductor chip 14 and module antenna 15 are a single unified component mounted by soldering electrode portions 42 to substrate 41. This arrangement enables standardizing the module, and thus inexpensively incorporating the module into electronic device 20. This configuration also enables easily installing the module in electronic device 20 when only limited space is available on substrate 41 or when RF interference results if the module is installed parallel to substrate 41. (RF interference is not a problem when module antenna 15 is disposed perpendicularly to substrate 41).

FIG. 2C shows an arrangement in which semiconductor chip 14 and module antenna 15 are a single unified component affixed to the inside of the case of electronic device 20 and connected to substrate 41 by way of a connector 43. This arrangement enables standardizing the module, and thus inexpensively incorporating the module into electronic device 20. Using a connector 43 also affords greater freedom in deciding where to locate module antenna 15 so that the antenna can be located where RF interference is not a problem, when such a problem otherwise exists in the area around the substrate 41.

FIG. 2D shows an arrangement in which only semiconductor chip 14 is mounted as a module on substrate 41; module antenna 15 is affixed within electronic device 20, for example to its inside case, and module antenna 15 is connected to substrate 41 by a connector 43. When substrate 41 is surrounded by RF interference and there is not enough space to locate module antenna 15 where there is no RF interference, this arrangement can be used by changing only the shape (configuration) of module antenna 15. This arrangement enables standardizing the module, and thus inexpensively incorporating the module into an electronic device 20. Furthermore, because module antenna 15 can be freely located where desired, this arrangement also enables locating module antenna 15 where there is no RF interference.

By thus adjusting the configuration of RFID tag module 10 and how the module is mounted or connected to substrate 41 according to the configuration of the electronic device in which module 10 is incorporated, RF interference can be minimized and the module can be inexpensively and easily disposed in electronic device 20.

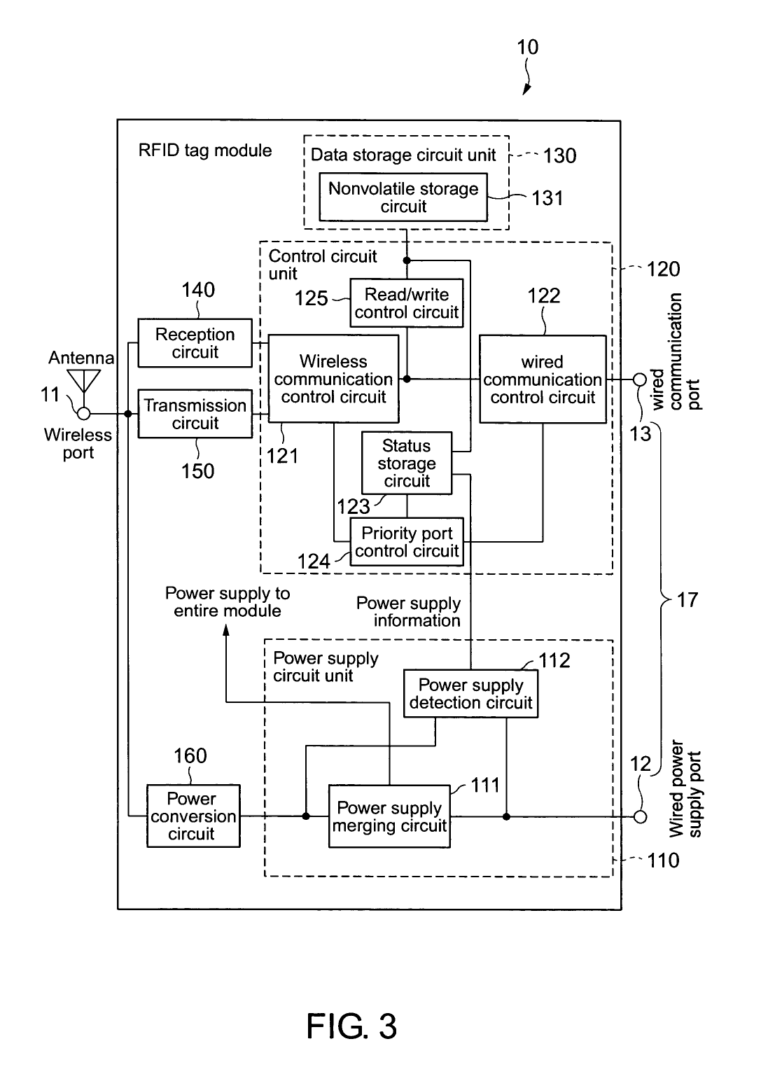

The control arrangement of RFID tag module 10 is described next with reference to FIG. 3. As previously explained, the interface of RFID tag module 10 has a wireless port 11 and a wired port 17, the latter of which is composed of a wired power supply port 12 and wired communication port 13. RFID tag module 10 also has a power supply circuit unit 110 for combining power supplied through wireless port 11 and wired power supply port 12 and supplying the combined power to the rest of the RFID tag module; a control circuit unit 120 for controlling operation of RFID tag module 10; a data storage circuit unit or data storage medium 130 for storing data received through wireless port 11 and wired communication port 13; a reception circuit 140 for receiving and passing to control circuit unit 120 data from wireless communication terminal 30 received through wireless port 11; a transmission circuit 150 for sending data acquired from control circuit unit 120 through wireless port 11 to wireless communication terminal 30; and a power conversion circuit 160 for converting radio wave power received from the wireless communication terminal 30 through wireless port 11 to power supply circuit unit 110.

Power supply circuit unit 110 has a power supply merging circuit 111 for combining power supplied from power supply ports 11 and 12, and a power supply detection circuit 112 for detecting if power is being supplied from ports 11 and/or 12 and the time at which supplying power starts from each port 11, 12.

Power supply merging circuit 111 supplies power to RFID tag module 10 insofar as power is supplied from either the wireless port 11 or the wired power supply port 12, and does not require power supplied from both ports 11 and 12.

Power supply detection circuit 112 starts operating when power supply circuit unit 110 starts supplying power to the module. Circuit 112 detects if power is being supplied from either or both of wireless port 11 and/or wired power supply port 12, and sends a power supply status report indicating the power supply status of the ports to the control circuit unit 120 (status storage circuit 123). Power supply detection circuit 112 also detects the time at which power supply from ports 11 and/or 12 started (that is, circuit 112 detects whether power was supplied first through wireless port 11 or through wired power supply port 12), and supplies the detection result as priority port information to control circuit unit 120.

Note that the power supply status report and priority port information are together referred to below as the power supply information.

Control circuit unit 120 also determines whether to enable or disable each of the communication ports 11 and 13 based on the power supply information acquired from power supply detection circuit 112 as described in further detail below.

Control circuit unit 120 has a wireless communication control circuit 121 for controlling the exchange of data with wireless communication terminal 30 through wireless port 11, reception circuit 140, and transmission circuit 150; a wired communication control circuit 122 for controlling data communication with electronic device 20 (and more specifically with device control circuit 22 as shown in FIG. 1) through wired port 17; a status storage circuit 123 for storing the power supply information acquired from power supply detection circuit 112 and the communication status of wireless communication control circuit 121 and wired communication control circuit 122; a priority port control circuit 124 for turning each of wireless communication control circuit 121 and wired communication control circuit 122 on or off based on the priority port information stored in status storage circuit 123; and a read/write control circuit 125 for reading/writing data. Read/write control circuit 125 interfaces between each of wireless communication control circuit 121 and wired communication control circuit 122 and data storage circuit unit 130.

When one or the other of wireless communication control circuit 121 or wired communication control circuit 122 is enabled by priority port control circuit 124, the enabled control circuit 121 or 122 allows communication between its corresponding communication port 11 or 13 and read/write control circuit 125. The other disabled communication control circuit is disconnected from read/write control circuit 125, such that it cannot communicate with read/write control circuit 125. If a communication request is received through the disabled communication port 11 or 13, the communication request is output to priority port control circuit 124, status storage circuit 123 is referenced, and if the other communication control circuit is communicating, a status report indicating that communication is disabled is returned to the requesting device (electronic device 20 or wireless communication terminal 30). If the other communication control circuit is not busy communicating (e.g., if communication has ended), the priority port control circuit 124 switches communication control.

Status storage circuit 123 stores the power supply information (the power supply status information and priority port information) generated when either wireless port 11 or wired power supply port 12 starts supplying power. Note that the priority port information is stored only once when the power supply starts while the power supply status information is updated regularly and thus stores the latest information. If the power supply from the disabled port starts while the power supply from the communication-enabled port 11 or 12 is interrupted, the priority port information is rewritten (updated) when the power supply is interrupted.

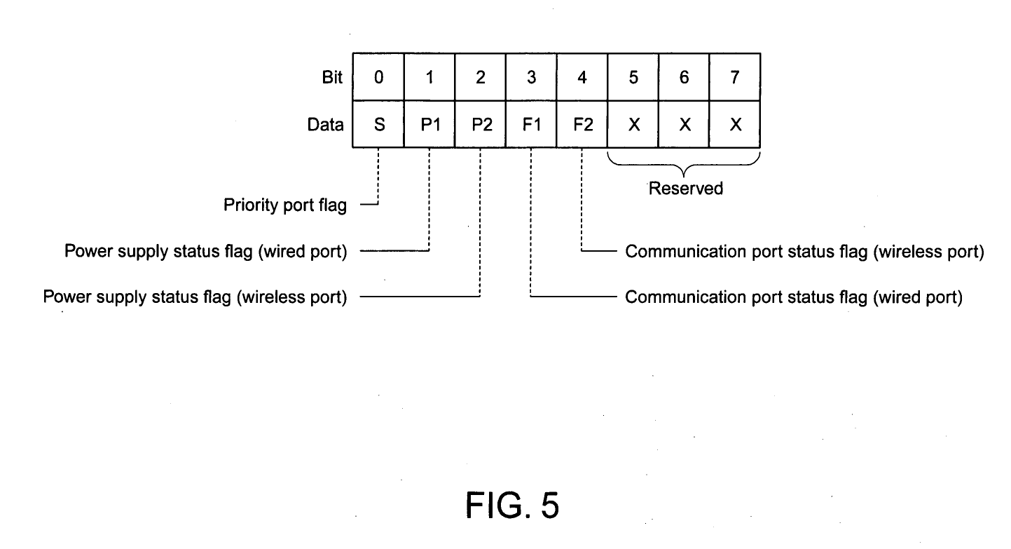

Status storage circuit 123 stores communication status information indicating whether communication port 11 or 13 (and corresponding communication control circuit 121 or 122) is being used for communication. This communication status information is set to indicate that data communication is in progress when data communication through either communication port 11 or 13 starts, and is reset to indicate that communication has ended when communication ends. The power supply status information, priority port information, and communication status information are stored as flags in status storage circuit 123 as described more fully below with reference to FIG. 5.

Priority port control circuit 124 enables wireless communication control circuit 121 when the wireless port 11 has priority based on the priority port information stored in status storage circuit 123, and enables wired communication control circuit 122 when the wired port 17 has priority.

When a communication switching command is received from communicating device 20 or 30 through the correspondingly enabled communication control circuit, and read/write control circuit 125 confirms from reading the power supply status information in status storage circuit 123 that power is being supplied from disabled port 11 or 12, the on/off state of both ports is switched (that is, the priority port information is rewritten in status storage circuit 123).

Furthermore, when a communication request is received from communicating device 20 or 30 through the disabled communication control circuit, the on/off status of both ports is switched as described above after confirming the communication status of the other communication control circuit.

Read/write control circuit 125 writes data acquired from the enabled communication control circuit (wireless communication control circuit 121 or wired communication control circuit 122) to data storage circuit unit 130 (specifically to nonvolatile storage circuit 131), and passes data read from data storage circuit unit 130 to whichever communication control circuit (wireless 121 or wired 122) is enabled. Furthermore, when a communication switching command is asserted through the enabled communication control circuit, read/write control circuit 125 reads the power supply status information from status storage circuit 123, and rewrites the priority port information if power is being supplied from the other port. Priority port control circuit 124 then switches communication control based on the priority port information rewritten in status storage circuit 123.

Data storage circuit unit 130 has a nonvolatile storage circuit 131 for storing information. More particularly, nonvolatile storage circuit 131 has specific areas allocated for storing parameter settings for the electronic device 20, maintenance information, and an error log.

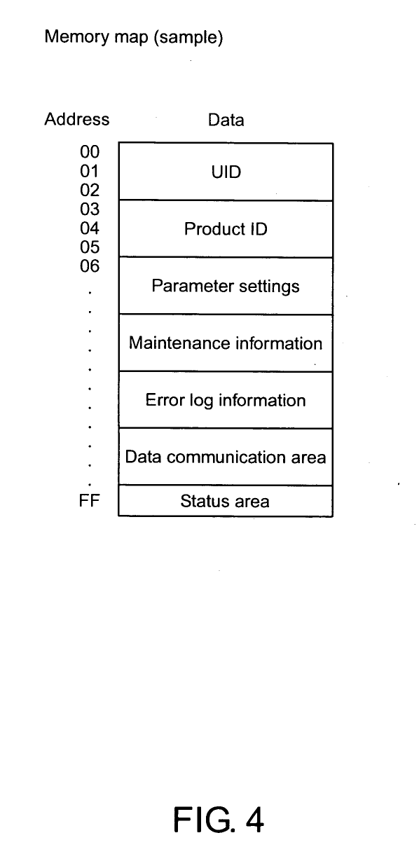

The memory map of RFID tag module 10 is described next with reference to FIG. 4. Nonvolatile storage circuit 131 is divided into discrete storage areas allocated to memory addresses 00 to FF to form a memory map such as that shown in FIG. 4. In the example shown in FIG. 4 a universal identifier (UID) for identifying RFID tag module 10 (semiconductor chip 14) is stored in memory area addresses 00 to 02, and a product ID (ID information) identifying the electronic device 20 in which RFID tag module 10 is installed is stored in memory area addresses 03 to 05. In addition, the parameter settings, maintenance information, error log, and data communication area used to implement the present invention are stored in memory areas allocated to addresses 06 and higher. Status storage circuit 123 is allocated to memory map address FF, and a status area used for reading and writing data with status storage circuit 123 is stored at memory address FF. This information can be read and written using specific commands common to electronic device 20, wireless communication terminal 30, and RFID tag module 10.

Note that the maintenance information and error log denote device information for electronic device 20, and are primarily written by device control circuit 22 (see FIG. 1) through wired communication port 13 and read by wireless communication terminal 30 through wireless port 11.

The UID is an identifier unique to a particular semiconductor chip and is commonly used in RFID systems to identify the associated semiconductor chip. The UID is also used for anti-collision control so that when multiple RFID tag modules 10 are simultaneously present in the communication range of wireless communication terminal 30, it can communicate with a particular RFID tag module 10 without interference from other nearby RFID tag modules. This UID is normally written in semiconductor chip 14 during chip manufacture, and cannot be changed.

The product ID is an ID for identifying the type of electronic device 20 in which RFID tag module 10 is installed or to which the module is connected, and can be written from device control circuit 22 through wired communication port 13. More specifically, the product ID is composed of information relating to the manufacturer of electronic device 20, information for determining the type of device, and a serial number, for example, and is an ID that is unique to electronic device 20 (product). The product ID is normally written to electronic device 20 during the manufacturing process and cannot be changed. Note that the product ID may be written by wireless communication terminal 30 instead of by device control circuit 22. By thus storing a product ID in nonvolatile storage circuit 131 of RFID tag module 10 and enabling wireless communication terminal 30 to read the product ID, a single wireless communication terminal 30 can interact with multiple types of electronic devices.

More specifically, wireless communication terminal 30 may read a wide range of information from electronic device 20 but cannot determine the type of information received until corresponding format data is received. In the present embodiment, wireless communication terminal 30 accesses, for example, a website maintained by the manufacturer of electronic device 20 based on the read product ID to acquire the necessary format data and thus communicate with the electronic device 20. The Electronic Product Code (EPC) network (a system that combines RFID and network technologies to automatically identify products or packages to which an RFID tag module is affixed for information sharing in supply chain management (SCM) operations) operated by EPC Global is preferably used to acquire this format data.

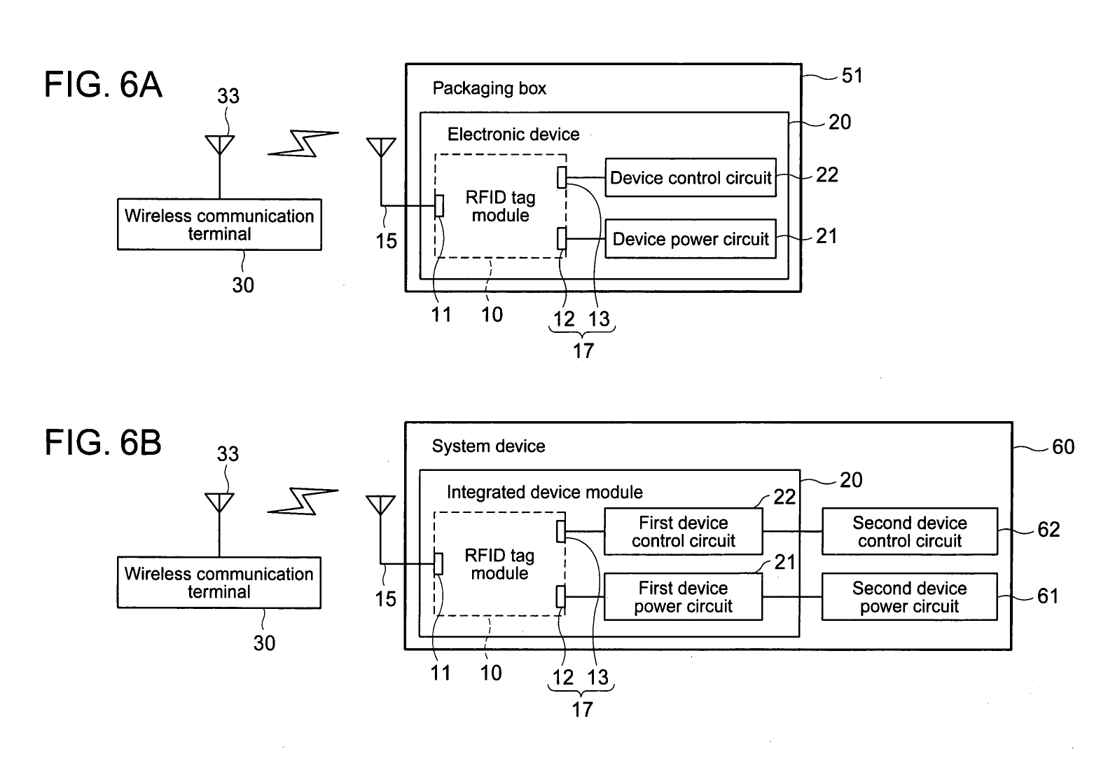

The parameter settings store the settings of parameters used to control the operation of electronic device 20 with which RFID tag module 10 is used, and can be written from wireless communication terminal 30 through wireless port 11. Device control circuit 22 reads the parameter settings from nonvolatile storage circuit 131 through wired communication port 13 as needed, and reflects these parameters in the initial settings and default settings of, for example, electronic device 20. By thus storing parameter settings in nonvolatile storage circuit 131 of RFID tag module 10, electronic device 20 can be customized as wanted by a customer when electronic device 20 is contained in a packaging box 51 as shown in FIG. 6A, for example, without opening the packaging box and without connecting a power supply. The parameter settings of electronic device 20 can also be changed even when it is operating without changing the interface connection.

Note that the parameter settings can also be written from device control circuit 22 through wired communication port 13 and not just from wireless communication terminal 30, and can be used by wireless communication terminal 30 to confirm the configuration of electronic device 20.

The maintenance information is information relating to the maintenance of electronic device 20 in which RFID tag module 10 is used, and is written by device control circuit 22 through wired communication port 13. Device control circuit 22 is configured to regularly update maintenance information of electronic device 20 in nonvolatile storage circuit 131. In the event electronic device 20 malfunctions, for example, the maintenance information written just before the malfunction can be read by wireless communication terminal 30 and used to determine the cause of the problem for repair. Wireless communication terminal 30 can also easily read the maintenance information even when electronic device 20 is a stand-alone device (such as a device without an external communication port and unable to receive data from a higher level host terminal, or a device without a human interface for reading and writing internal data). Furthermore, because the maintenance information can be read when electronic device 20 is installed (regardless of whether electronic device 20 is operating or not and regardless of the on/off status of the power supply), the maintenance information can also be used for preventive maintenance.

The maintenance information can also be written through wireless port 11 from wireless communication terminal 30, instead of from device control circuit 22. This enables wireless communication terminal 30 to write repair data to nonvolatile storage circuit 131 when parts are replaced in electronic device 20 so that this repair data can also be read and used for subsequent repair and maintenance.

Note, further, that this maintenance information preferably includes information about how many times parts with a certain life cycle have been used, the consumption or remaining amount of consumable goods, the operating time of the device, and a parts replacement history, for example. If electronic device 20 is a printer, for example, the maintenance information may, and preferably does, include information about ink ribbon or toner consumption and a maintenance counter reading, for example.

The error log stores information about errors that occurred in electronic device 20 in which RFID tag module 10 is used. As is the case with the maintenance information, the error log can be written through wired communication port 13 from device control circuit 22, and can be read through wireless port 11 from wireless communication terminal 30. By thus storing an error log in nonvolatile storage circuit 131 of RFID tag module 10, the error log can be easily read from wireless communication terminal 30 even when electronic device 20 is a stand-alone device. The error log can also be read even when electronic device 20 has malfunctioned and is not working, and the cause of the malfunction can thus be easily determined.

Note that the error log also contains error data such as information that is recorded when the electronic device is used improperly or illegally, and errors that occur when the program does not run normally.

The data communication area is used when data other than the foregoing parameter settings, maintenance information, and error log is exchanged between electronic device 20 (device control circuit 22) and wireless communication terminal 30. Wireless communication terminal 30 can also be used to write a program, which is then read by electronic device 20 to control operation. As a result, this area can also be used to update the firmware of electronic device 20.

The status area is used for reading and writing information (the power supply status information, priority port information, and communication status information) stored by status storage circuit 123. As shown in FIG. 5, data is stored in the status area as flags allocated to specific bits. The priority port flag, for example, corresponds to the priority port information, and is stored as the value S at bit 0. Therefore, if wireless communication control circuit 121 is enabled when the priority port flag is ON, communication (that is, sending and receiving by wireless communication control circuit 121) is enabled through wireless port 11 when the priority port flag is ON, and communication (that is, sending and receiving by wired communication control circuit 122) through wired port 17 is enabled when the priority port flag is OFF. The relation between the enable/disable states of communication ports 11 and 13 and the ON/OFF states of the priority port flag may of course be just the reverse.

The power supply status flag corresponds to the power supply status information. The status of wired power supply port 12 is written as data P1 to bit 1, and the status of wireless port 11 is written as data P2 to bit 2. When power is supplied from port 11 or 12, the flag corresponding to that port is set to ON.

The communication port status flag corresponds to the communication status information. The status of wired communication port 13 is written as data Fl to bit 3, and the status of wireless port 11 is written as data F2 to bit 4. The corresponding flag is set ON in this embodiment when communication port 11 or 13 is being used for data communication.

Bits 5 through 7 are not used in this embodiment of the invention.

By thus writing data stored by means of status storage circuit 123 in this status area, the device communicating with electronic device 20 can know the communication status of the communication port (11 or 13) to which the communicating device is connected, and control can be passed to the other communication port of RFID tag module 10.

The status area shown in FIG. 5 is described herein as being allocated to a specific memory area in nonvolatile storage circuit 131 as shown in FIG. 4. The invention is not so limited, however; rather, the status area could be rendered as an independent register separate from the memory, and the register could be read using a command separate from the memory read/write commands.

In this embodiment the invention has been described using, by way of example, a RFID tag module 10 integrated into electronic device 20 as shown in FIG. 1. As shown in FIG. 6B, however, the present invention can also be used with an electronic device 20 having a built-in RFID tag module 10 (that is, an electronic device with an internal module) that is further incorporated in a system device 60. In this arrangement wired power supply port 12 of RFID tag module 10 is connected to first device power supply circuit 21, which, in turn, is connected to a second device control circuit 62 for supplying power to system device 60. Wired communication port 13 of RFID tag module 10 is connected to first device control circuit 22, which is connected to a second device control circuit 62 for controlling system device 60. This arrangement enables first device control circuit 22 to communicate with RFID tag module 10 and to read from and write to the second device control circuit 62. Data can thus be handled as though wireless communication terminal 30 and second device control circuit 62 are communicating.

Furthermore, if integral electronic device 20 and/or system device 60 malfunctions, wireless communication terminal 30 can read and write data using data storage circuit unit 130 of RFID tag module 10 as described above even if system device 60 is contained in a packaging box 51 (see FIG. 6A).

An RFID tag module 10 according to the present invention as described above has both a wireless port 11 and a wired port 17 (composed of a wired communication port 13 and wired power supply port 12), and can thus exchange data with wireless communication terminal 30 through wireless port 11 and with electronic device 20 through wired communication port 13. By connecting wired power supply port 12 to device power supply circuit 21 and wired communication port 13 to device control circuit 22, RFID tag module 10 can be incorporated into and used with electronic device 20. RFID tag module 10 can thus receive power from device 20, and can also receive power from terminal 30 through wireless port 11.

Yet further, because communication is enabled and disabled based on when and where (port 11 or 12) power supply starts, data can be selectively transmitted through both communication ports 11 and 13 to and from the same data storage circuit unit 130.

Furthermore, if a communication request is received from the communication port (either communication port 11 or 13) whose corresponding communication control circuit 121 or 122 is disabled, the disabled communication port can detect if the other port (the enabled port) is being used for communication by referencing status storage circuit 123 though priority port control circuit 124. If the enabled communication port is in use a busy status is returned to the requesting communication control circuit and the disabled communication port remains disabled. If the enabled communication port is not in use, priority port control circuit 124 switches the enable/disable status of both ports. In other words, if a communication request is received from a communication device for which communication is turned off, the device is not simply told that communication is disabled. Instead, the status of the communication ports can be switched according to the communication status of the port for which communication is enabled so that communication from a device connected to a communication port that is turned off can be enabled. As a result, the enabled/disabled status of both communication ports 11 and 13 can be switched without interrupting the power supply from power supply port 11 and 12 for which communication is enabled and then rewriting the priority port information.

Furthermore, if a communication switching command for switching communication from the enabled communication port to the other communication port is received from the enabled communication port, which could be either wireless port 11 or wired communication port 13, priority port control circuit 124 first references status storage circuit 123 to confirm that power is being supplied from the requested communication port before changing the enabled/disabled state of the communication ports, and thus reliably passes data communication control to the other communication port. This method also enables easily switching communication between communication ports 11 and 13 without needing to interrupt the power supply from the enabled power supply port 11 or 12.

By storing the parameter settings of electronic device 20 in data storage circuit unit 130 of RFID tag module 10, electronic device 20 can be customized according to the customer's needs prior to shipping electronic device 20, for example, without opening packaging box 51 or connecting a power supply. The parameter settings of electronic device 20 can also be changed even while electronic device 20 is operating without connecting electronic device 20 to a higher level host terminal.

Furthermore, by storing maintenance information and/or an error log for electronic device 20 in data storage circuit unit 130 of RFID tag module 10, data can be easily read by wireless communication terminal 30 even when electronic device 20 is a stand-alone device (such as a device without an external communication port and unable to receive data from a higher level host terminal, or a device without a human interface for reading and writing internal data) and this information can thus be used effectively when a malfunction occurs, for example. Furthermore, because the maintenance information can be read by wireless communication terminal 30 when electronic device 20 is installed (regardless of whether electronic device 20 is operating or not and regardless of the on/off status of the power supply), the maintenance information can also be used for preventive maintenance. When parts are replaced in electronic device 20, wireless communication terminal 30 can also write repair data to nonvolatile storage circuit 131 and this repair data can then be read and used for subsequent repair and maintenance.

By storing a product ID identifying electronic device 20 in data storage circuit unit 130, the type of electronic device 20 can also be determined by wireless communication terminal 30 reading the product ID. By accessing a website that contains this information and is maintained by electronic device 20 manufacturer based on this device type information, format data required to interpret signals from electronic device 20 can also be acquired, and a single wireless communication terminal 30 can thus be used to read data from various types of electronic devices.

If either wireless communication control circuit 121 or wired communication control circuit 122 is disabled and a communication request is received through the associated communication port 11 or 13, the disabled communication control circuit confirms the communication status of the other communication control circuit and returns a communication disabled status if communication on the other port is in progress (if communication is not in progress, priority port control circuit 124 switches communication control). However, in another embodiment, if communication is disabled, the communication control circuit can simply return a communication disabled status without confirming the communication status of the other communication control circuit. This arrangement simplifies control when a communication request is received.

Furthermore, when priority port control circuit 124 receives a communication switching command from communication port 11 or 13 enabled for communication, read/write control circuit 125 references status storage circuit 123 to confirm that power is being supplied from the other power supply port 11 or 12 before switching communication control. Communication control could, however, be switched (by changing the ON/OFF status of the priority port flag) when a communication switching command is received regardless of whether power is being supplied from the other power supply port. This enables communication to begin as soon as power is supplied from the other power supply port.

RFID tag module 10 is incorporated into electronic device 20 for use in the embodiments explained above, but data communication with electronic device 20 is also possible by connecting wired port 17 to an external communication port (not shown in the figure) of electronic device 20.

The port (wireless port 11 or wired power supply port 12) supplies power first is enabled (set as the priority port) in the foregoing embodiments. However, if power is supplied from both power supply ports, a parameter controlling which communication port 11 or 13 is first given priority can be set and stored in data storage circuit unit 130. The user can also change this priority parameter setting in data storage circuit unit 130 using wireless communication terminal 30.

The control program of device control circuit 22 of electronic device 20 and control circuit unit 120 of RFID tag module 10 can also be rendered as a computer-executable program that is stored or carried on a computer-readable storage medium. Examples of such computer-readable storage media include hard disks, flash ROM, memory cards, compact flash, smart media, and memory sticks, compact discs, magneto-optical discs, DVD media, and floppy disks. The computer-readable medium may also be an electromagnetic carrier wave.

While RFID tag module 10 of this invention has been disclosed in the context of an information communication system 1, the invention is not limited to this arrangement. Rather, module 10 can be used in various devices and systems having a built-in computer, including automobiles and home appliances.

Although preferred embodiments of the present invention has been described with reference to the accompanying drawings, various modifications and changes will be apparent to those skilled in the art in light of the foregoing disclosure. Such changes and modifications are part of the invention to the extent that they fall within the spirit and scope of the appended claims.

1. An IC tag module, comprising:
a wireless port through which the IC tag module is adapted to send and receive data and to receive power wirelessly;
a wired port including a wired communication port through which the IC tag module is adapted to send and receive data and a wired power supply port through which the IC tag module is adapted to receive power;
a power supply circuit configured to combine power received through the wireless port and the wired power supply port and to supply power to the IC tag module, the power supply circuit being further configured to detect whether power is first supplied through the wireless port or the wired port;
a data storage medium configured to store data received through the wireless port and wired communication port; and
a control circuit configured to control the IC tag module, wherein the control circuit enables communication between the data storage medium and whichever of either the wireless port or the wired port through which power was first supplied, if power is supplied through both the wireless port and the wired port, and disables communication through the other port.

2. An IC tag module as described in claim 1, wherein, when a communication request is asserted by a device through whichever of either the wireless port or the wired port is disabled, the control circuit returns a communication disabled status message to the device.

3. An IC tag module as described in claim 2, wherein, when a communication request is asserted through whichever of either the wireless port or the wired port is disabled, the control circuit detects if the enabled port is being used for data communication, and returns a communication disabled status message if the enabled port is being used for data communication, and switches the enabled/disabled status of both ports if the enabled port is not being used for data communication.

4. An IC tag module as described in claim 1, wherein the control circuit switches the enabled/disabled status of both ports when a command is received from the enabled port for switching communication to the other port.

5. An IC tag module as described in claim 4, wherein the power supply circuit regularly detects from which port power is being supplied, and when a command is received from the enabled port for switching communication to the other port, the control circuit first confirms that power is being supplied from the other port before switching the enabled/disabled status of both ports.

6. An electronic device comprising an IC tag module as described in claim 1, the electronic device further comprising:
a device control circuit configured to send data to and receive data from the IC tag module through the wired communication port; and
a device power supply circuit configured to supply power to the IC tag module through the wired power supply port.

7. An information communication system comprising an IC tag module as described in claim 1, the information communication system further comprising:
an electronic device configured to send data to and receive data from the IC tag module, and to supply power to the IC tag module through the wired port; and
a wireless communication terminal configured to send data to and receive data from the IC tag module, and to supply power to the IC tag module through the wireless port;
wherein the IC tag module stores parameter settings of the electronic device in the data storage medium,
the wireless communication terminal reads and writes the parameter settings in the data storage medium through the wireless port, and
the electronic device reads the parameter settings written in the data storage medium through the wired port, and customizes the electronic device based on the parameter settings or changes the parameter settings.

8. An information communication system as described in claim 7, wherein the electronic device writes at least one of electronic device maintenance information or error log information in the data storage medium through the wired port, and the wireless communication terminal reads and writes at least one of electronic device maintenance information or error log information in the data storage medium through the wireless port.

9. An information communication system as described in claim 7, wherein the data storage medium stores ID information identifying the electronic device.

10. A communication control method for an IC tag module capable of data communication through a wireless port and a wired port, comprising:
switching the enabled/disabled status of each port according to a communication request asserted through the currently enabled port.

11. A communication control method for an IC tag module as described in claim 10, wherein power is supplied to the IC tag module through at least one of the wireless port or the wired port, the communication control method further comprising:
switching the enabled/disabled status of each port according to presence or absence of at least one of the communication request or presence or absence of supply power.
